(19) United States
(12) Patent Application Publication
(10) Pub. No.: US 2026/0058129 A1
(43) Pub. Date: Feb. 26, 2026

(54) FLUORINE RICH ORGANIC/INORGANIC COATINGS FOR LITHIUM AND MANGANESE RICH MATERIALS

(71) Applicant: GM GLOBAL TECHNOLOGY OPERATIONS LLC, DETROIT, MI (US)

(72) Inventors: Meng Jiang, Rochester Hills, MI (US); Vamakshi Yadav, Sterling Heights, MI (US)

(21) Appl. No.: 18/810,988

(22) Filed: Aug. 21, 2024

(51) Int. Cl. H01M 4/36; B60L 50/64; H01M 4/131; H01M 4/1391; H01M 4/505; H01M 4/62; H01M 10/0525; H01M 10/058; H01M 50/211

(52) U.S. Cl. CPC H01M 4/366; B60L 50/64; H01M 4/131; H01M 4/1391; H01M 4/505; H01M 4/623; H01M 4/625; H01M 10/0525; H01M 10/058; H01M 50/211; H01M 2220/20

(57) ABSTRACT

Aspects of the disclosure include lithium and manganese rich (LMR) battery cells having fluorine rich organic/inorganic coatings and methods of manufacturing the same. An exemplary vehicle includes an electric motor and a battery pack electrically coupled to the electric motor. The battery pack includes a battery cell that includes an anode current collector, an anode active material layer in direct contact with a surface of the anode current collector, a cathode current collector, a cathode active material layer in direct contact with a surface of the cathode current collector, and a separator. The cathode active material layer includes a lithium and manganese rich (LMR) cathode active material coated with a fluorine rich organic/inorganic coating. The fluorine rich organic/inorganic coating includes carbon nanotube (CNT) filled polytetrafluoroethylene (PTFE) nanofibers physisorbed onto the LMR cathode active material.

### INTRODUCTION

The present disclosure relates to battery cell manufacturing, and particularly to the use of fluorine rich organic/inorganic coatings for lithium and manganese rich (LMR) materials.

Lithium-ion batteries, also known as lithium-ion cells, are a type of rechargeable battery technology that have gained significant attention due to their relatively high energy density and long cycle life compared to other battery chemistries. The anode (negative electrode) in a lithium-ion cell is typically made of graphite, a carbon-based material that can reversibly intercalate and deintercalate lithium ions. The cathode (positive electrode) can be made of various lithium-containing compounds, such as lithium transition metal oxides (e.g., LiCoO₂, LiNiMnCoO₂, etc.), lithium metal phosphates (e.g., LiFePO₄), or other suitable materials that can reversibly intercalate and deintercalate lithium ions.

The electrodes in a lithium-ion cell are separated by an electrolyte, which is typically a lithium salt dissolved in an organic solvent, a solid polymer or solid-state electrolyte. The electrolyte acts as a medium for lithium ion transport between the anode and cathode during charge and discharge processes. Current collectors provide a conductive pathway for electrons to flow between the electrodes and an external circuit. The current collector for the anode is typically made of copper or a copper alloy, while the current collector for the cathode is typically made of aluminum or an aluminum alloy.

During the discharge process, lithium ions deintercalate from the anode and migrate through the electrolyte to intercalate into the cathode material, while electrons flow through the external circuit to power a device. During charging, this process is reversed, with lithium ions being extracted from the cathode and intercalated back into the anode.

### SUMMARY

In one exemplary embodiment a vehicle includes an electric motor and a battery pack electrically coupled to the electric motor. The battery pack includes a battery cell that includes an anode current collector, an anode active material layer in direct contact with a surface of the anode current collector, a cathode current collector, a cathode active material layer in direct contact with a surface of the cathode current collector, and a separator. The cathode active material layer includes a lithium and manganese rich (LMR) cathode active material coated with a fluorine rich organic/inorganic coating. The fluorine rich organic/inorganic coating includes carbon nanotube (CNT) filled polytetrafluoroethylene (PTFE) nanofibers physisorbed onto the LMR cathode active material.

In addition to one or more of the features described herein, in some embodiments, the LMR cathode active material includes nickel at a nickel to manganese mole ratio of between 30:70 and 80:20.

In some embodiments, the LMR cathode active material includes a lithium to transition metal mole ratio of between 1.06 and 1.60.

In some embodiments, the LMR cathode active material includes a CNT to PTFE weight ratio of between 2.0 and 5.0 weight percent CNT.

In some embodiments, the LMR cathode active material includes a CNT/PTFE to LMR weight ratio of between 0.5 and 10.0 weight percent CNT/PTFE.

In some embodiments, the LMR cathode active material includes alumina at a weight ratio of between 0.1 and 1.0 weight percent.

In some embodiments, a weight ratio of LMR cathode active material in the cathode active material layer is between 80 and 99 weight percent.

In another exemplary embodiment a battery cell includes, an anode current collector, an anode active material layer in direct contact with a surface of the anode current collector, a cathode current collector, a cathode active material layer in direct contact with a surface of the cathode current collector, and a separator. The cathode active material layer includes a lithium and manganese rich (LMR) cathode active material coated with a fluorine rich organic/inorganic coating. The fluorine rich organic/inorganic coating includes carbon nanotube (CNT) filled polytetrafluoroethylene (PTFE) nanofibers physisorbed onto the LMR cathode active material.

In some embodiments, the LMR cathode active material includes nickel at a nickel to manganese mole ratio of between 30:70 and 80:20.

In some embodiments, the LMR cathode active material includes a lithium to transition metal mole ratio of between 1.06 and 1.60.

In some embodiments, the LMR cathode active material includes a CNT to PTFE weight ratio of between 2.0 and 5.0 weight percent CNT.

In some embodiments, the LMR cathode active material includes a CNT/PTFE to LMR weight ratio of between 0.5 and 10.0 weight percent CNT/PTFE.

In some embodiments, the LMR cathode active material includes alumina at a weight ratio of between 0.1 and 1.0 weight percent.

In some embodiments, a weight ratio of LMR cathode active material in the cathode active material layer is between 80 and 99 weight percent.

In yet another exemplary embodiment a method can include forming an anode current collector, an anode active material layer in direct contact with a surface of the anode current collector, a cathode current collector, a cathode active material layer in direct contact with a surface of the cathode current collector, and a separator. The cathode active material layer includes a lithium and manganese rich (LMR) cathode active material coated with a fluorine rich organic/inorganic coating. The fluorine rich organic/inorganic coating includes carbon nanotube (CNT) filled polytetrafluoroethylene (PTFE) nanofibers physisorbed onto the LMR cathode active material.

In some embodiments, the LMR cathode active material includes nickel at a nickel to manganese mole ratio of between 30:70 and 80:20.

In some embodiments, the LMR cathode active material includes a lithium to transition metal mole ratio of between 1.06 and 1.60.

In some embodiments, the LMR cathode active material includes a CNT to PTFE weight ratio of between 2.0 and 5.0 weight percent CNT.

In some embodiments, the LMR cathode active material includes a CNT/PTFE to LMR weight ratio of between 0.5 and 10.0 weight percent CNT/PTFE.

In some embodiments, the LMR cathode active material includes alumina at a weight ratio of between 0.1 and 1.0 weight percent.

In some embodiments, a weight ratio of LMR cathode active material in the cathode active material layer is between 80 and 99 weight percent.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2A is an example battery cell in accordance with one or more embodiments;

FIG. 2B is a detailed view of the battery cell shown in FIG. 2A in accordance with one or more embodiments;

FIG. 3 is a manufacturing process for coating lithium and manganese rich (LMR) materials with carbon nanotube filled polytetrafluoroethylene (PTFE) nanofibers in accordance with one or more embodiments;

FIG. 4 is a manufacturing process for coating LMR materials with carbon nanotube filled PTFE nanofibers in accordance with one or more embodiments;

FIG. 5 is a manufacturing process for coating LMR materials with carbon nanotube filled PTFE nanofibers in accordance with one or more embodiments; and

FIG. 6 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As the demand for energy storage systems offering higher energy densities, faster charging, and extended operational lifespans increases, driven in part by the proliferation of electric vehicles, significant challenges have been imposed on the materials used in battery cell components. Research and development efforts are continuously directed toward identifying novel materials and manufacturing techniques that can meet escalating demands on battery cells and other energy storage systems.

Lithium Manganese Rich (LMR) materials have emerged as a promising candidate for next-generation lithium-ion battery cathodes due to their potential for high energy density and improved performance. These materials, typically represented as xLi₂MnO₃₍₁₋ₓ₎LiMO₂ (where M=Ni, Co, Mn, etc.), offer several advantages that make them attractive for researchers and battery manufacturers alike. For example, LMR cathodes can deliver significantly higher capacities compared to conventional lithium-ion battery cathodes. Theoretical capacities exceeding 250 mAh/g have been reported, which is notably higher than current li-ion cathodes. Other advantages, such as the abundance of manganese and a reduced reliance on cobalt, make LMR materials very desirable for large-scale production. Despite their promising attributes, LMR materials face several challenges that hinder their widespread commercial adoption. Perhaps most notably, LMR materials typically need to be cycled (activated, charged) at relatively high voltages (that is, brought to a voltage of at least 4.4 to 4.6) to achieve their high-capacity benefit. Unfortunately, more side reactions will take place at such high voltages, which may lead to capacity fading, usage of excess electrolyte, and gassing issues.

This disclosure introduces a lithium-ion battery that leverages fluorine rich organic/inorganic coatings for lithium and manganese rich (LMR) materials and methods of manufacturing the same. Specifically, three novel composite coatings are described herein. In the first composite coating, polytetrafluoroethylene (PTFE) nanofibers are filled with carbon nanotubes (CNT). The PTFE/CNT composites are mixed with LMR cathode active materials to form, via physisorption, LMR coated by carbon filled PTFE nanotubes. In the second composite coating, a calcination step is introduced after forming the LMR coated by carbon filled PTFE nanotubes. The result is a fluorine-rich carbon coating on LMR. In the third composite coating, an alumina precursor is included in the mixture of the PTFE/CNT composites and LMR cathode active materials and a calcination step is introduced after shear mixing or spring drying the resulting composite. The result is a fluorine-doped alumina-carbon coating. Advantageously, the fluorine rich organic/inorganic coating layers described herein can act like a protection layer that mitigates side reactions during high voltage LMR cycling.

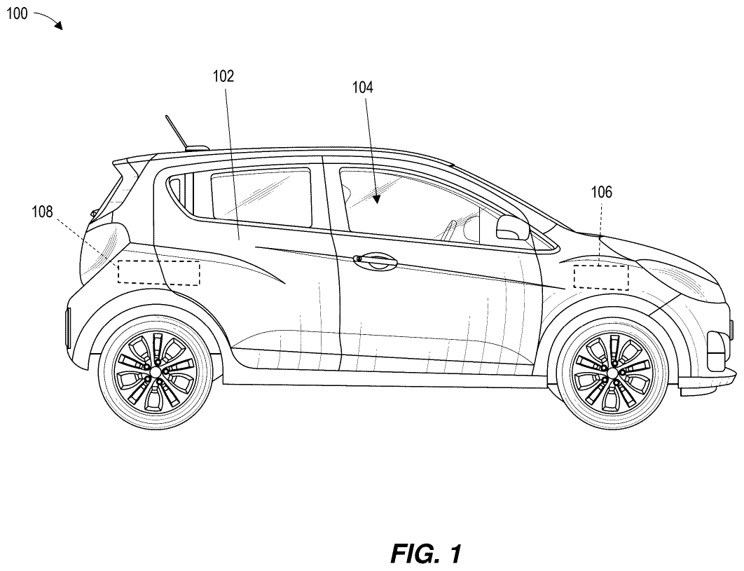

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

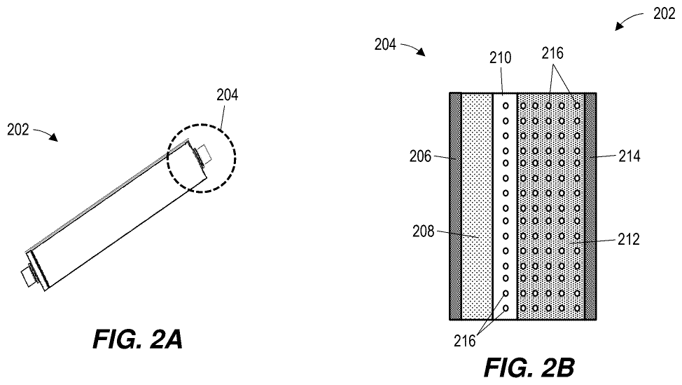

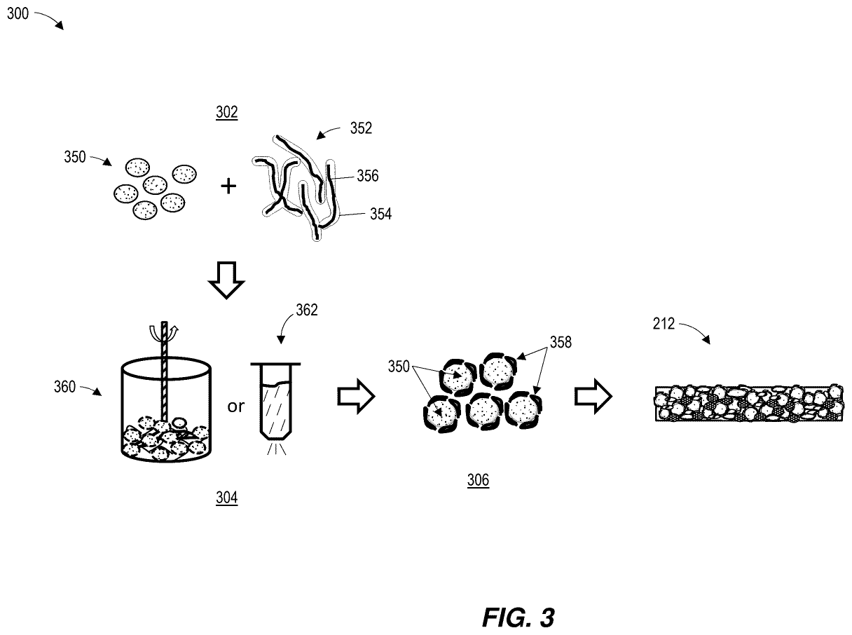

As will be detailed herein, the battery pack 108 includes one or more battery modules, battery cells, and/or battery pouches (collectively, a “battery cell”) having lithium and manganese rich (LMR) based lithium-ion cell(s) with fluorine rich organic/inorganic coatings. An example battery cell is shown in FIG. 2A. A detailed view of the battery cell of FIG. 2A is shown in FIG. 2B. Three novel composite coatings are described with respect to FIGS. 3, 4, and 5.

FIG. 2A illustrates an example battery cell 202 in accordance with one or more embodiments. The battery cell 202 can be incorporated as one of a number of battery cells in a battery pack (e.g., the battery pack 108 in FIG. 1). FIG. 2B illustrates a detailed view 204 of the battery cell 202 shown in FIG. 2A in accordance with one or more embodiments. As shown in FIG. 2B, the battery cell 202 includes, from left to right, an anode current collector 206, an anode active material layer 208, a separator 210, a cathode active material layer 212, and a cathode current collector 214, configured and arranged as shown.

The anode current collector 206 and the cathode current collector 214 can be made of sheets, foils (continuous or with punches or cuts), or mesh of conductive materials. For example, the cathode current collector 214 can be made of aluminum foil, stainless steel, and/or titanium foil. Other materials are possible, such as, for example, semimetals (e.g., tin, graphite) and alloys of the metals and/or semimetals thereof. In some embodiments, the cathode current collector 214 is made of aluminum foil. The anode current collector 206 can include, for example, copper foil and/or one or more graphene layers. In some embodiments, the anode current collector 206 is made of copper foil. The thickness of a current collector can be approximately 10 to 20 μm, although other thicknesses are within the contemplated scope of this disclosure.

The anode active material layer 208 is not meant to be particularly limited, and can include, for example, lithium metal, activated carbon powder, graphite, silicon, silicon-graphite composites, tin, tin oxide (SnO₂), tin-cobalt alloys, lithium titanate (Li₄Ti₅O₁₂, LTO), and combinations thereof.

As will be described in greater detail with respect to FIGS. 3, 4, and 5, the cathode active material layer 212 can include lithium and manganese rich (LMR) cathode materials having fluorine rich organic/inorganic coatings. In some embodiments, the LMR cathode material can include nickel and manganese at mole ratios of 30:70 to 80:20, respectively. In some embodiments, the cathode active material layer 212 can further include Co in a range between 0 and 20 percent. In some embodiments, the LMR cathode material can include lithium and a transition metal at mole ratios of 1.06 to 1.60, respectively. In some embodiments, the cathode active material layer 212 includes LMR cathode materials coated with carbon nanotube filled PTFE nanofibers (refer to FIG. 3). In some embodiments, the CNT/PTFE ratio can range from 2 to 5 weight percent CNT. The composite CNT/PTFE-LMR weight ratio can range from 0.5 to 10 weight percent CNT/PTFE.

In some embodiments, the LMR cathode materials can include, for example, lithium manganese rich oxide (LMR), lithium manganese oxide (LMO), and lithium nickel manganese oxide (LNMO). Other materials include nickel manganese cobalt (NMC) variants, such as NMC 622, NMC 811, and NMC 532. These materials are part of the layered oxide class of cathodes and can be modified to create LMR-type structures. Still other options include lithium nickel manganese spinel (LNMO) and lithium-rich manganese-rich layered NMC materials (LMR-NMC). While not meant to be particularly limited, the weight ratio of the coated LMR in the cathode active material layer 212 can be between 80 percent and 99 percent (by weight).

Depending on battery construction (e.g., conventional vs. bi-polar current collectors, etc.) the separator 210 is optional but, if included, can be positioned to isolate the anode active material layer 208 and the cathode active material layer 212. The separator 210 can include dielectric materials such as, for example, polyethylene (PE), polypropylene (PP), polyethylene terephthalate (PET), synthetic fluoropolymer such as polytetrafluoroethylene (PTFE), and composites thereof, although other dielectrics are within the contemplated scope of this disclosure. In some embodiments, the separator 210 may include a thermally stable coating layer to improve shrinkage behavior (e.g., a porous ceramic coating or porous ester type polymer coating including, for example, polyimide, polyamide, polyimide-polyamide (PI/PA) copolymer, etc.). The thickness of the separator 210 can be approximately 12 to 16 μm, although other thicknesses are within the contemplated scope of this disclosure.

As further shown in FIG. 2B, the battery cell 202 includes an electrolyte 216. The electrolyte 216 can include a liquid electrolyte, a solid electrolyte, and/or a polymer electrolyte. In some embodiments, the electrolyte 216 is a liquid electrolyte (as shown) that permeates, covers, and/or penetrates the cathode active material layer 212. In some embodiments, liquid electrolyte partially penetrates the separator 210 (as shown). In some embodiments, electrolyte 216 includes a lithium salt dissolved in a solvent, although other liquid electrolytes are possible and all such configurations are within the contemplated scope of this disclosure. The lithium salt chosen in the electrolyte 216 is not meant to be particularly limited and can vary depending on the needs of a given application. In some embodiments, for example, the lithium salt includes lithium hexafluorophosphate (LiPF₆), lithium bis(trifluoromethanesulfonyl)imide (LiTFSI), lithium bis(oxalato)borate (LiBOB), lithium difluoro(oxalato)borate (LiDFOB), lithium bis(fluorosulfonyl)imide (LiFSI), lithium trifluoromethanesulfonate (LiTf), lithium tetrafluoroborate (LiBF₄), lithium nitrate (LiNO₃), and/or lithium bis(pentafluoroethanesulfonyl)imide (LiBETI), and combinations thereof.

The concentration of the lithium salt(s) in the electrolyte 216 will vary depending on the lithium salt(s) chosen and the needs of a given application. The lithium salt concentration can be varied, for example, to target a predetermined ionic conductivity (increasing the salt concentration leads to an increase in ionic conductivity up to a certain point, beyond which the conductivity may decrease due to increased ion-ion interactions and viscosity), to provide suitable levels of salt dissociation and ion mobility (for a given lithium salt, there is a minimum threshold concentration, below which the salt may not fully dissociate, leading to a lack of charge carriers; conversely, there is a maximum threshold concentration, beyond which the increased ion-ion interactions hinder ion mobility sufficiently to reduce conductivity), to provide a target electrolyte viscosity, to target a predetermined electrochemical stability window, and/or to influence the formation and composition of the SEI layer on the lithium metal anode. In some embodiments, the lithium salts can be formed to a concentration of 0.1 M to 2 M, for example, 0.8 M, although other concentrations are within the contemplated scope of this disclosure.

FIG. 3 illustrates a manufacturing process 300 for coating LMR materials (e.g., cathode active materials in cathode active material layer 212 of FIG. 2B) with carbon nanotube filled PTFE nanofibers in accordance with one or more embodiments. As shown in FIG. 3, the manufacturing process 300 includes step 302, step 304, and step 306, configured and arranged as shown.

In some embodiments, step 302 includes forming or otherwise sourcing an LMR-type cathode active material (LMR CAM) 350 and carbon nanotube filled PTFE nanofibers 352. The LMR CAM 350 can be formed from lithium and manganese rich cathode materials such as those previously discussed with respect to FIG. 2B. The carbon nanotube filled PTFE nanofibers 352 can include PTFE nanofiber membranes 354 filled with carbon nanotubes 356.

In some embodiments, the carbon nanotube filled PTFE nanofibers 352 can be formed from a preparation of polyethylene oxide (PEO), also known as polyethylene glycol (PEG), and a range of different content CNT water dispersions, as desired. For example, 0.409 g PEO can be blended with CNT water dispersions having a CNT content of 0.1, 0.5, 1.0, 3.0 and 5.0 weight percent vs. PTFE. PEO and CNT water dispersions can be blended using suitable processing conditions. For example, PEO and CNT water dispersions can be blended at 40 degrees Celsius for 3 hours by magnetic stirring. After blending, a PTFE emulsion can be added.

Continuing with the previous example, a 5.0 g PTFE emulsion (60 weight percent PTFE) can be added to a blended PEO/CNT solution using magnetic stirring for 6 hours. After PTFE incorporation, the resulting PTFE/PEO/CNT nanofiber membranes can be subjected to electrospinning, for example, under a feeding rate of 1 mL/h, voltage of 15 kV, and an atmospheric pressure of 0.1 MPa at 20 degrees Celsius. The collection distance can be set as desired, for example, to 13 cm. The resulting PTFE/PEO/CNT precursor can be collected and dried, for example, at 60 degrees Celsius for 12 hours. Finally, the dried PTFE/PEO/CNT precursor can be sintered at, for example, 380 degrees Celsius to obtain the carbon nanotube filled PTFE nanofibers 352. Observe that the weight percent of CNTs in the carbon nanotube filled PTFE nanofibers 352 will vary according to the CNT content (e.g., 3 weight percent, etc.) of the CNT water dispersions used in step 302.

In some embodiments, step 304 includes coating the LMR CAM 350 with the carbon nanotube filled PTFE nanofibers 352. The LMR CAM 350 can be coated with the carbon nanotube filled PTFE nanofibers 352 using any suitable process, such as, for example, shear mixing 360, dry mixing (not separately shown), wet coating (not separately shown), and/or spray drying 362. It should be appreciated that the specific conditions for mixing and/or drying will vary depending on the given application. For example, a spray drying process might have a concentration of powder in solution of 1 g/30 mL, a nozzle cleaner frequency of 0.2 Hz, a drying air flow rate of 30 L/min, a drying gas temperature of 140° C., and a flow rate of sample to the nozzle of 5 cc/min. In some embodiments, the carbon nanotube filled PTFE nanofibers 352 are physisorbed onto surfaces of the LMR CAM 350, thereby forming, via physisorption, a fluorine rich organic/inorganic coating 358.

In some embodiments, step 306 includes finishing the electrode making process using the fluorine rich organic/inorganic coating 358 obtained in step 304. While not meant to be particularly limited, the step 306 can include forming a completed cathode active material layer (e.g., cathode active material layer 212 of FIG. 2B) using the LMR CAM 350 and the fluorine rich organic/inorganic coating 358. In some embodiments, the cathode active material layer 212 in battery cell 202 includes LMR material at nickel/manganese mole ratio of 30:70 to 80:20, a lithium/transition metal mole ratio of 1.06 to 1.60, a CNT/PTFE ratio of 2.0 to 5.0 weight percent CNT, and a CNT/PTFE ratio of 0.5 to 10.0 weight percent CNT/PTFE. In some embodiments, the cathode active material layer 212 can further include Co in a range between 0 and 20 percent. Step 306 can further include forming any other component and/or subcomponent of a battery cell (e.g., battery cell 202 shown in FIG. 2B), such as, for example, forming the anode current collector 206, the anode active material layer 208, the separator 210, and the cathode current collector 214. Advantageously, the fluorine rich organic/inorganic coating 358 mitigates side reactions in the battery cell 202 at the cathode-electrolyte interface when cycling at relatively high LMR cycling voltages (e.g., 4.4 V to 4.6 V).

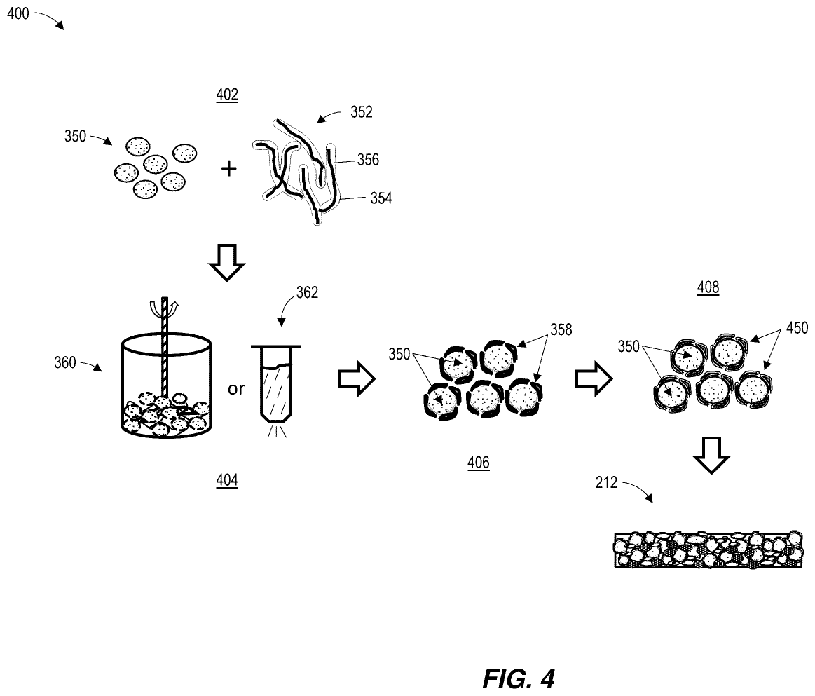

FIG. 4 illustrates a manufacturing process 400 for coating LMR materials (e.g., cathode active materials in cathode active material layer 212 of FIG. 2B) with carbon nanotube filled PTFE nanofibers in accordance with one or more embodiments. Manufacturing process 400 is similar to the manufacturing process 300 discussed with respect to FIG. 3, except that manufacturing process 400 introduces a calcination step after coating the LMR CAM 350 with the carbon nanotube filled PTFE nanofibers 352 (refer to step 304 of FIG. 3). As shown in FIG. 4, the manufacturing process 400 includes step 402, step 404, step 406, and step 408, configured and arranged as shown.

In some embodiments, step 402 includes forming or otherwise sourcing an LMR-type cathode active material (LMR CAM) 350 and carbon nanotube filled PTFE nanofibers 352, in a similar manner as discussed with respect to step 302 of FIG. 3. The LMR CAM 350 can be formed from lithium and manganese rich cathode materials such as those previously discussed with respect to FIG. 2B. The carbon nanotube filled PTFE nanofibers 352 can include PTFE nanofiber membranes 354 filled with carbon nanotubes 356.

In some embodiments, step 404 includes coating the LMR CAM 350 with the carbon nanotube filled PTFE nanofibers 352, thereby forming a fluorine rich organic/inorganic coating 358 in a similar manner as discussed with respect to step 304 of FIG. 3.

In some embodiments, step 406 includes subjecting the fluorine rich organic/inorganic coating 358 obtained in step 404 to calcination, thereby obtaining a fluorine-doped carbon coating 450. In some embodiments, step 406 includes calcination at a temperature of 600 degrees Celsius, although other temperatures are within the contemplated scope of this disclosure. In some embodiments, step 406 includes calcination under an inert carrier gas at a temperature of between 500 and 800 degrees Celsius for a period of between 6 and 12 hours (e.g., 8 hours).

In some embodiments, step 408 includes finishing the electrode making process using the fluorine-doped carbon coating 450 obtained in step 406. While not meant to be particularly limited, the step 408 can include forming a completed cathode active material layer (e.g., cathode active material layer 212 of FIG. 2B) using the LMR CAM 350 and the fluorine-doped carbon coating 450. In some embodiments, the cathode active material layer 212 in battery cell 202 includes LMR material at nickel/manganese mole ratio of 30:70 to 80:20, a lithium/transition metal mole ratio of 1.06 to 1.60, a CNT/PTFE ratio of 2.0 to 5.0 weight percent CNT, and a CNT/PTFE ratio of 0.5 to 10.0 weight percent CNT/PTFE. Step 408 can further include forming any other component and/or subcomponent of a battery cell (e.g., battery cell 202 shown in FIG. 2B), such as, for example, forming the anode current collector 206, the anode active material layer 208, the separator 210, and the cathode current collector 214.

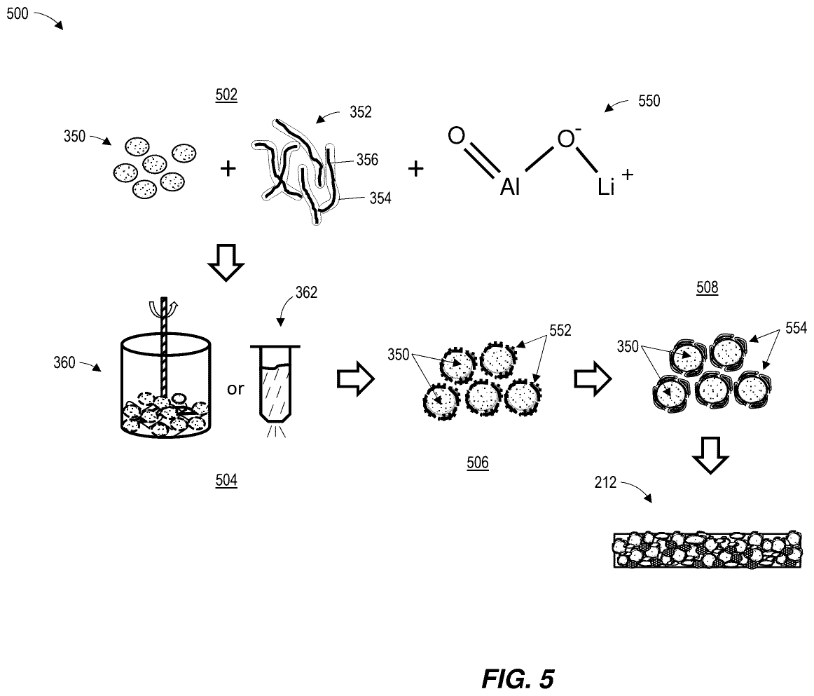

FIG. 5 illustrates a manufacturing process 500 for coating LMR materials (e.g., cathode active materials in cathode active material layer 212 of FIG. 2B) with carbon nanotube filled PTFE nanofibers in accordance with one or more embodiments. Manufacturing process 500 is similar to the manufacturing process 400 discussed with respect to FIG. 4, except that manufacturing process 500 introduces the incorporation of an alumina precursor 550 prior to coating the LMR CAM 350 with the carbon nanotube filled PTFE nanofibers 352 (refer to step 404 of FIG. 4). As shown in FIG. 5, the manufacturing process 500 includes step 502, step 504, step 506, and step 508, configured and arranged as shown.

In some embodiments, step 502 includes forming or otherwise sourcing an LMR-type cathode active material (LMR CAM) 350 and carbon nanotube filled PTFE nanofibers 352, in a similar manner as discussed with respect to step 302 of FIG. 3 and step 402 of FIG. 4. The LMR CAM 350 can be formed from lithium and manganese rich cathode materials such as those previously discussed with respect to FIG. 2B. The carbon nanotube filled PTFE nanofibers 352 can include PTFE nanofiber membranes 354 filled with carbon nanotubes 356. However, in contrast to the manufacturing processes 300 and 400, step 502 additionally includes forming or otherwise sourcing alumina precursor 550. In some embodiments, alumina precursor 550 includes one or more of lithium aluminate, colloidal alumina, aluminum oxide, aluminum nitrate, aluminum hydroxide, aluminum isopropoxide, and aluminum sulfate.

In some embodiments, step 504 includes coating the LMR CAM 350 with the carbon nanotube filled PTFE nanofibers 352 and alumina precursor 550, thereby forming a fluorine rich organic/inorganic alumina coating 552. In some embodiments, the alumina precursor 550 is combined with the LMR CAM 350 and the carbon nanotube filled PTFE nanofibers 352 at a weight ratio of between 0.1 and 1.0 percent by weight.

In some embodiments, step 506 includes subjecting the fluorine rich organic/inorganic alumina coating 552 obtained in step 504 to calcination, thereby obtaining a fluorine-doped alumina-carbon coating 554. In some embodiments, step 506 includes calcination at a temperature of 600 degrees Celsius, although other temperatures are within the contemplated scope of this disclosure. In some embodiments, step 506 includes calcination under an inert carrier gas at a temperature of between 500 and 800 degrees Celsius.

In some embodiments, step 508 includes finishing the electrode making process using the fluorine-doped alumina-carbon coating 554 obtained in step 506. While not meant to be particularly limited, the step 508 can include forming a completed cathode active material layer (e.g., cathode active material layer 212 of FIG. 2B) using the LMR CAM 350 and the fluorine-doped alumina-carbon coating 554. In some embodiments, the cathode active material layer 212 in battery cell 202 includes LMR material at nickel/manganese mole ratio of 30:70 to 80:20, a lithium/transition metal mole ratio of 1.06 to 1.60, a CNT/PTFE ratio of 2.0 to 5.0 weight percent CNT, a CNT/PTFE ratio of 0.5 to 10.0 weight percent CNT/PTFE, and LiAlO2 (alumina) at a weight ratio of between 0.1 and 1.0 weight percent. Step 508 can further include forming any other component and/or subcomponent of a battery cell (e.g., battery cell 202 shown in FIG. 2B), such as, for example, forming the anode current collector 206, the anode active material layer 208, the separator 210, and the cathode current collector 214. Advantageously, the integration of the alumina precursor 550 within the fluorine-doped alumina-carbon coating 554 offers a robust organic/inorganic interface, and can enhance conductivity and improve cycling stability of the battery cell 202.

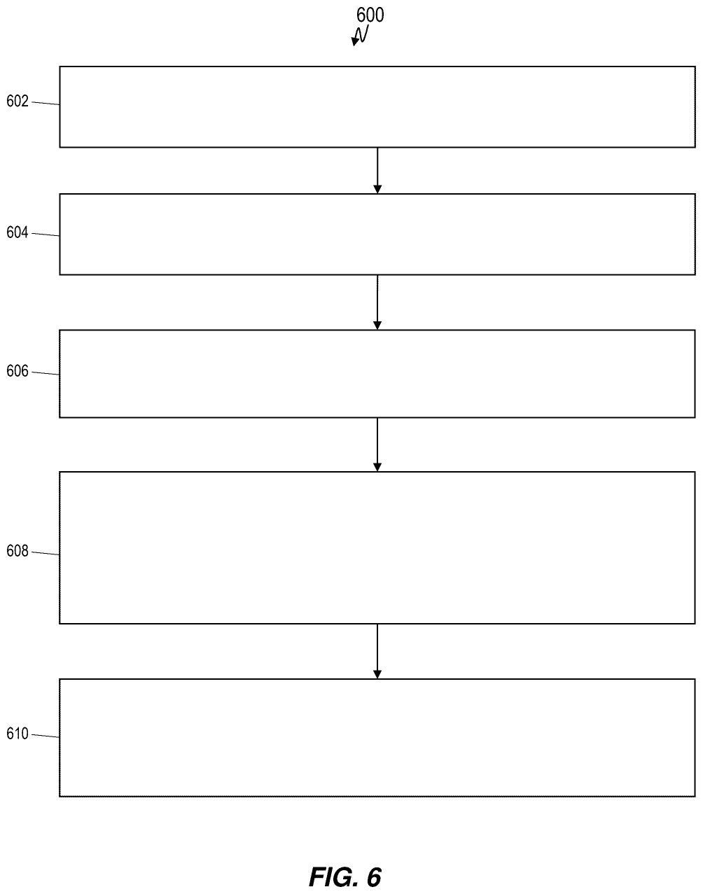

Referring now to FIG. 6, a flowchart 600 for providing fluorine rich organic/inorganic coatings for lithium and manganese rich (LMR) materials is generally shown according to an embodiment. The flowchart 600 is described in reference to FIGS. 1-5 and may include additional steps not depicted in FIG. 6. Although depicted in a particular order, the blocks depicted in FIG. 6 can be rearranged, subdivided, and/or combined.

At block 602, the method includes forming an anode current collector.

At block 604, the method includes forming an anode active material layer in direct contact with a surface of the anode current collector.

At block 606, the method includes forming a cathode current collector.

At block 608, the method includes forming a cathode active material layer in direct contact with a surface of the cathode current collector. In some embodiments, the cathode active material layer includes an LMR cathode active material coated with a fluorine rich organic/inorganic coating. In some embodiments, the fluorine rich organic/inorganic coating includes carbon nanotube filled polytetrafluoroethylene nanofibers physisorbed onto the LMR cathode active material.

At block 610, the method includes forming a separator positioned between the anode active material layer and the cathode active material layer.

In some embodiments, the LMR cathode active material includes nickel at a nickel to manganese mole ratio of between 30:70 and 80:20. In some embodiments, the cathode active material layer 212 can further include Co in a range between 0 and 20 percent.

In some embodiments, the LMR cathode active material includes a lithium to transition metal mole ratio of between 1.06 and 1.60.

In some embodiments, the LMR cathode active material includes a CNT to PTFE weight ratio of between 2.0 and 5.0 weight percent CNT.

In some embodiments, the LMR cathode active material includes a CNT/PTFE to LMR weight ratio of between 0.5 and 10.0 weight percent CNT/PTFE.

In some embodiments, the LMR cathode active material includes alumina at a weight ratio of between 0.1 and 1.0 weight percent, and wherein a weight ratio of LMR cathode active material in the cathode active material layer is between 80 and 99 weight percent.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

When an element such as a layer, film, region, or substrate is referred to as being “on” another element, it can be directly on the other element or intervening elements may also be present. In contrast, when an element is referred to as being “directly on”another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor; and
a battery pack electrically coupled to the electric motor, the battery pack comprising a plurality of battery cells, each battery cell of the plurality of battery cells comprising:
an anode current collector;
an anode active material layer in direct contact with a surface of the anode current collector;
a cathode current collector;
a cathode active material layer in direct contact with a surface of the cathode current collector, the cathode active material layer comprising a lithium and manganese rich (LMR) cathode active material coated with a fluorine rich organic/inorganic coating; and
a separator positioned between the anode active material layer and the cathode active material layer;
wherein the fluorine rich organic/inorganic coating comprises carbon nanotube (CNT) filled polytetrafluoroethylene (PTFE) nanofibers physisorbed onto the LMR cathode active material.

2. The vehicle of claim 1, wherein the LMR cathode active material comprises nickel at a nickel to manganese mole ratio of between 30:70 and 80:20.

3. The vehicle of claim 1, wherein the LMR cathode active material comprises a lithium to transition metal mole ratio of between 1.06 and 1.60.

4. The vehicle of claim 1, wherein the LMR cathode active material comprises a CNT to PTFE weight ratio of between 2.0 and 5.0 weight percent CNT.

5. The vehicle of claim 1, wherein the LMR cathode active material comprises a CNT/PTFE to LMR weight ratio of between 0.5 and 10.0 weight percent CNT/PTFE.

6. The vehicle of claim 1, wherein the LMR cathode active material comprises alumina at a weight ratio of between 0.1 and 1.0 weight percent.

7. The vehicle of claim 1, wherein a weight ratio of LMR cathode active material in the cathode active material layer is between 80 and 99 weight percent.

8. A battery cell comprising:
an anode current collector;
an anode active material layer in direct contact with a surface of the anode current collector;
a cathode current collector;
a cathode active material layer in direct contact with a surface of the cathode current collector, the cathode active material layer comprising a lithium and manganese rich (LMR) cathode active material coated with a fluorine rich organic/inorganic coating; and
a separator positioned between the anode active material layer and the cathode active material layer;
wherein the fluorine rich organic/inorganic coating comprises carbon nanotube (CNT) filled polytetrafluoroethylene (PTFE) nanofibers physisorbed onto the LMR cathode active material.

9. The battery cell of claim 8, wherein the LMR cathode active material comprises nickel at a nickel to manganese mole ratio of between 30:70 and 80:20.

10. The battery cell of claim 8, wherein the LMR cathode active material comprises a lithium to transition metal mole ratio of between 1.06 and 1.60.

11. The battery cell of claim 8, wherein the LMR cathode active material comprises a CNT to PTFE weight ratio of between 2.0 and 5.0 weight percent CNT.

12. The battery cell of claim 8, wherein the LMR cathode active material comprises a CNT/PTFE to LMR weight ratio of between 0.5 and 10.0 weight percent CNT/PTFE.

13. The battery cell of claim 8, wherein the LMR cathode active material comprises alumina at a weight ratio of between 0.1 and 1.0 weight percent.

14. The battery cell of claim 8, wherein a weight ratio of LMR cathode active material in the cathode active material layer is between 80 and 99 weight percent.

15. A method comprising:
forming an anode current collector;
forming an anode active material layer in direct contact with a surface of the anode current collector;
forming a cathode current collector;
forming a cathode active material layer in direct contact with a surface of the cathode current collector, the cathode active material layer comprising a lithium and manganese rich (LMR) cathode active material coated with a fluorine rich organic/inorganic coating; and
forming a separator positioned between the anode active material layer and the cathode active material layer;
wherein the fluorine rich organic/inorganic coating comprises carbon nanotube (CNT) filled polytetrafluoroethylene (PTFE) nanofibers physisorbed onto the LMR cathode active material.

16. The method of claim 15, wherein the LMR cathode active material comprises nickel at a nickel to manganese mole ratio of between 30:70 and 80:20.

17. The method of claim 15, wherein the LMR cathode active material comprises a lithium to transition metal mole ratio of between 1.06 and 1.60.

18. The method of claim 15, wherein the LMR cathode active material comprises a CNT to PTFE weight ratio of between 2.0 and 5.0 weight percent CNT.

19. The method of claim 15, wherein the LMR cathode active material comprises a CNT/PTFE to LMR weight ratio of between 0.5 and 10.0 weight percent CNT/PTFE.

20. The method of claim 15, wherein the LMR cathode active material comprises alumina at a weight ratio of between 0.1 and 1.0 weight percent, and wherein a weight ratio of LMR cathode active material in the cathode active material layer is between 80 and 99 weight percent.
